(19) United States
(12) Patent Application Publication
(10) Pub. No.: US 2010/0011009 A1
(43) Pub. Date: Jan. 14, 2010

(54) System and method for monitoring document conformance

(75) Inventors: John Michael Hoopes, Washington, IL (US); Shannon Marie Pettit, Morton, IL (US); Pauline C. Agbodjan-Prince, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/216,583

(22) Filed: Jul. 8, 2008

(51) Int. Cl. G06F 7/00; G06F 17/30

(52) U.S. Cl. 707/100; 707/E17.009

(57) ABSTRACT

A system and method for monitoring document conformance is disclosed. The method may include populating a database with data indicative of contents of a plurality of documents, the plurality of documents including a first document associated with a first supplying entity located at a first facility and a second document associated with a second supplying entity located at a second facility. The method may further include comparing data in the populated database with information indicative of a standard. The method may further include identifying, based on the comparison, repeated instances of non-conforming documents to the standard.

### TECHNICAL FIELD

The present disclosure relates generally to a system and method for monitoring documents and, more particularly, to a system and method for monitoring document conformance.

### BACKGROUND

When products are bought and sold, documents detailing the transactions are often created and exchanged. The documents may include, for example, purchase orders, invoices, schedules, shipping notices, packing lists, and/or warehouse receipts. These documents may be hardcopy paper documents or electronic documents. The contents of the documents may include information such as product numbers, supplier names, product descriptions, quantities, dates, prices, etc.

Individual suppliers may each have unique formats and/or types of information associated with one or more particular documents. Additionally, a receiving entity that receives products and/or services from the suppliers may have multiple receiving locations. The multiple receiving locations and the different document formats may lead to difficulty in ensuring the overall conformance of the documents to a set of standards. Therefore, a system and method for monitoring document conformance to a set of standards may be desirable.

One method of monitoring document conformance is described in U.S. Patent Application Publication No. 2005/0187874 (“the '874 publication”) filed by Sanal. The '874 publication discloses an import compliance system and method. The system of the '874 publication includes a compliance system configured to perform various checks with respect to data received via an electronic data interface. Specifically, the compliance system can check data for conformance with expected formats and completeness, flag inconsistencies, and notify appropriate personnel of any inconsistencies. The conformance and compliance checks of the system of the '874 publication are performed to ensure that the export/import process may be accomplished efficiently and with minimal errors, and may identify issues prior to submission of an entry declaration to customs or prior to actual shipment of goods.

Although the system of the '874 publication may perform conformance and compliance checks, it may not track inconsistencies to identify repeated instances of the inconsistencies. Additionally, the system of the '874 publication may not communicate with data providers to identify and resolve data submission issues affecting the inconsistencies.

The disclosed system and method is directed towards improving upon existing systems and methods for monitoring document conformance.

### SUMMARY

An aspect of the present disclosure is directed to a method for monitoring document conformance. The method may include populating a database with data indicative of contents of a plurality of documents, the plurality of documents including a first document associated with a first supplying entity located at a first facility and a second document associated with a second supplying entity located at a second facility. The method may further include comparing data in the populated database with information indicative of a standard. The method may further include identifying, based on the comparison, repeated instances of non-conforming documents to the standard.

In another aspect, the present disclosure is directed to a computer-readable medium for use on a computing system, the computer-readable medium including computer-executable instructions for performing a method for monitoring document conformance. The method may include populating a database with data indicative of contents of a plurality of documents, the plurality of documents including a first document associated with a first supplying entity located at a first facility and a second document associated with a second supplying entity located at a second facility. The method may further include comparing data in the populated database with information indicative of a standard. The method may further include identifying, based on the comparison, repeated instances of non-conforming documents to the standard.

In yet another aspect, the present disclosure is directed to a system for monitoring document conformance. The system may include a database configured to be populated with data indicative of contents of a plurality of documents, the plurality of documents including a first document associated with a first supplying entity located at a first facility and a second document associated with a second supplying entity located at a second facility. The system may further include a central processing unit associated with the database. The central processing unit may be configured to compare data in the populated database with information indicative of a standard, and identify, based on the comparison, repeated instances of non-conforming documents to the standard.

### BRIEF DESCRIPTION OF THE DRAWINGS

FIG. 1 is a block diagram of an exemplary architecture associated with a system for monitoring document conformance to a set of standards, consistent with certain disclosed embodiments; and

FIG. 2 is a flowchart illustrating an exemplary method for monitoring document conformance to a set of standards in connection with the system of FIG. 1, consistent with certain disclosed embodiments.

### DETAILED DESCRIPTION

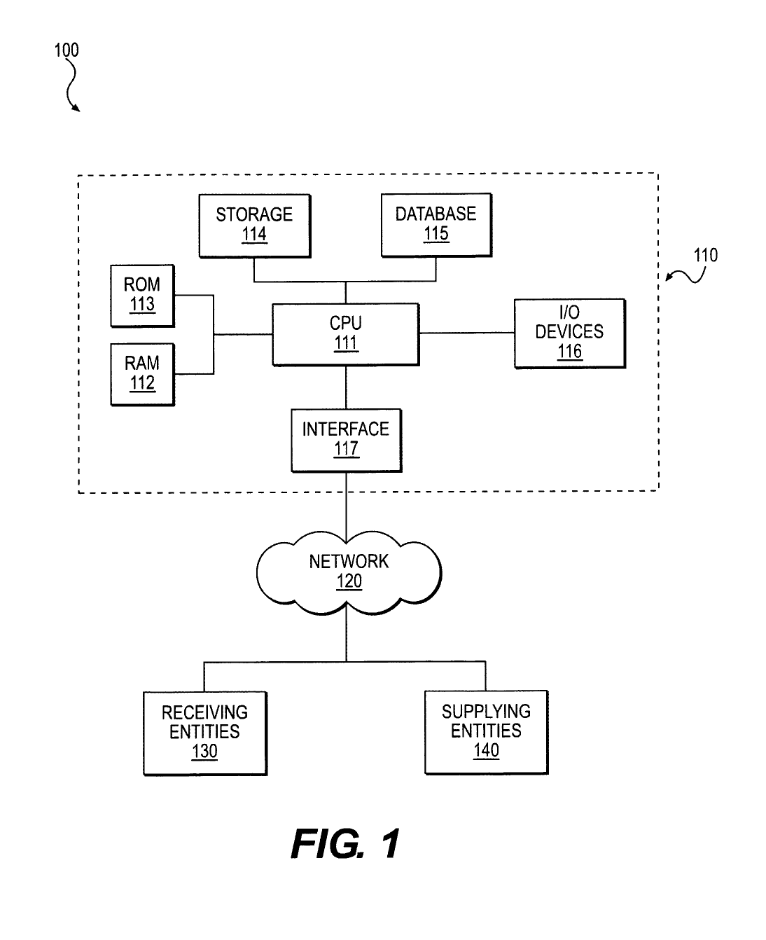

FIG. 1 illustrates an exemplary system 100 in which principles and methods consistent with the disclosed embodiments may be implemented. System 100 may be employed in a supply chain or logistics network, and may be configured to monitor document conformance to a set of standards. For example, system 100 may be configured to receive, from a plurality of supplying entities located at different geographical locations, data indicative of the contents of, for example, shipping documents. After the data is received, system 100 may use the data to verify that the shipping documents have, for example, accurate delivery or receipt dates, accurate quantity numbers for delivered products, accurate delivery address locations, etc. System 100 may include computing system 110, network 120, receiving entities 130, and supplying entities 140.

Computing system 110 may be associated with a business that comprises a plurality of receiving locations, i.e., a plurality of receiving entities 130, configured to receive delivered products. Computing system 110 may be located in a corporate office associated with receiving entities 130, or may be located in one of receiving entities 130.

Computing system 110 may be configured to receive data indicative of the contents of shipping documents. Computing system 110 may monitor, store, analyze, distribute, report, process, record, and/or sort the received data. Computing system 110 may perform these functions to ensure, for example, that the data, and therefore the shipping documents, have accurate delivery or receipt dates, accurate quantity numbers for delivered products, accurate delivery address locations, etc. Additional and/or different standards may be determined by managers at computing system 110 and/or managers at one or more of receiving entities 130.

Computing system 110 may include one or more hardware and/or software components such as, for example, a central processing unit (CPU) 111, a random access memory (RAM) module 112, a read-only memory (ROM) module 113, a storage 114, a database 115, one or more input/output (I/O) devices 116, and an interface 117. Additionally, computing system 110 may include one or more software components or applications to perform specific processing and analysis functions associated with the disclosed embodiments. Computing system 110 may include, for example, a mainframe, a server, a desktop, a laptop, and the like.

CPU 111 may include one or more processors, each configured to execute instructions and process data to perform functions associated with computing system 110. As illustrated in FIG. 1, CPU 111 may be connected to RAM 112, ROM 113, storage 114, database 115, I/O devices 116, and interface 117. CPU 111 may be configured to execute computer program instructions to perform various processes and methods consistent with certain disclosed embodiments. The computer program instructions may be loaded into RAM 112 for execution by CPU 111.

RAM 112 and ROM 113 may each include one or more devices for storing information associated with an operation of computing system 110 and/or CPU 111. For example, ROM 113 may include a memory device configured to access and store information associated with computing system 110, including information for identifying and monitoring data conformance. RAM 112 may include a memory device for storing data associated with one or more operations performed by CPU 111. For example, instructions from ROM 113 may be loaded into RAM 112 for execution by CPU 111.

Storage 114 may include any type of storage device configured to store any type of information used by CPU 111 to perform one or more processes consistent with the disclosed embodiments. For example, storage 114 may include one or more magnetic and/or optical disk devices, such as hard drives, CD-ROMs, DVD-ROMs, or any other type of media storage device.

Database 115 may be configured to store historical data such as, for example, data associated with previously received purchase orders, invoices, schedules, shipping notices, packing lists, and/or warehouse receipts. The historical data may be used by CPU 111 to monitor the conformance of documents to a set of standards. As an example, CPU 111 may compare received data with corresponding historically accurate data in database 115 to ensure the received data conforms to a set of standards. Historical data may include, for example, supplier contact information, supplier identification numbers, etc.

Database 115 may include one or more software and/or hardware components that store, organize, sort, filter, and/or arrange the historical data used by computing system 110. Database 115 may be configured as a relational database, distributed database, or any other suitable database format. A relational database may be in tabular form where data may be organized and accessed in various ways. A distributed database may be dispersed or replicated among different locations within a network. Database 115 may also include one or more analysis tools for analyzing information within database 115. Database 115 may store additional and/or different information than that listed above.

I/O devices 116 may include one or more components configured to communicate information with a user associated with computing system 110. For example, I/O devices 116 may include a console with an integrated keyboard and mouse to allow a user to input parameters associated with computing system 110. I/O devices 116 may also include a user-accessible disk drive (e.g., a USB port, a floppy, CD-ROM, or DVD-ROM drive, etc.) to allow a user to input data stored on a portable media device. Additionally, I/O devices 116 may include one or more displays or other peripheral devices, such as, for example, a printer, a camera, a microphone, a speaker system, an electronic tablet, or any other suitable type of input/output device.

Interface 117 may include one or more components configured to transmit and/or receive data via network 120. In addition, interface 117 may include one or more modulators, demodulators, multiplexers, de-multiplexers, network communication devices, wireless devices, antennas, modems, and any other type of device configured to enable data communication via any suitable communication network. It is further anticipated that interface 117 may be located remotely from CPU 111, RAM 112, ROM 113, storage 114, database 115, and one or more I/O devices 116.

Computing system 110 may include additional, fewer, and/or different components than those listed above and it is understood that the components listed above are exemplary only and not intended to be limiting. For example, one or more of the hardware components listed above may be implemented using software. According to one embodiment, storage 114 may include a software partition associated with one or more other hardware components of computing system 110. Additional hardware or software may also be required to operate computing system 110. Such hardware and software may include, for example, security applications, authentication systems, dedicated communication systems, or any other suitable hardware of software configured to support operations of computing system 110. The hardware and/or software may be interconnected and accessed as required by authorized users. In addition, one or more portions of computing system 110 may be hosted and/or operated by a third party.

As explained, computing system 110 may access network 120 via interface 117. Network 120 may embody any appropriate communication network allowing communication between or among one or more entities. Network 120 may include, for example, the Internet, a local area network, a workstation peer-to-peer network, a direct link network, a wireless network, or any other suitable communication platform. Interface 117 may be communicatively coupled with network 120 using wired connections, wireless connections, or any combination of wired and wireless connections.

Receiving entities 130 may comprise a plurality of receiving locations that are part of a distribution network. Receiving entities 130 may include any facility used for receipt, storing, holding, and/or assembly of inventory for a business. In one embodiment, one or more of receiving entities 130 may include a warehouse that receives sub-components of a product. The sub-components may be used to form a whole product, which may later be sold. In another embodiment, one or more of receiving entities 130 may store replacement parts for heavy machines, and/or on or off-highway vehicles. The replacement parts may later be sold to customers that desire the replacement parts.

Supplying entities 140 may comprise one or more entities that distributes products to other entities, such as, for example, one or more customers, dealers, wholesalers, merchants, authorized resellers, etc. It is understood that supplying entities 140 may also provide desired products to receiving entities 130. As an example, supplying entities 140 may supply receiving entities 130 with products such as, for example, raw materials, production goods, sub-assemblies, components, sub-components, etc.

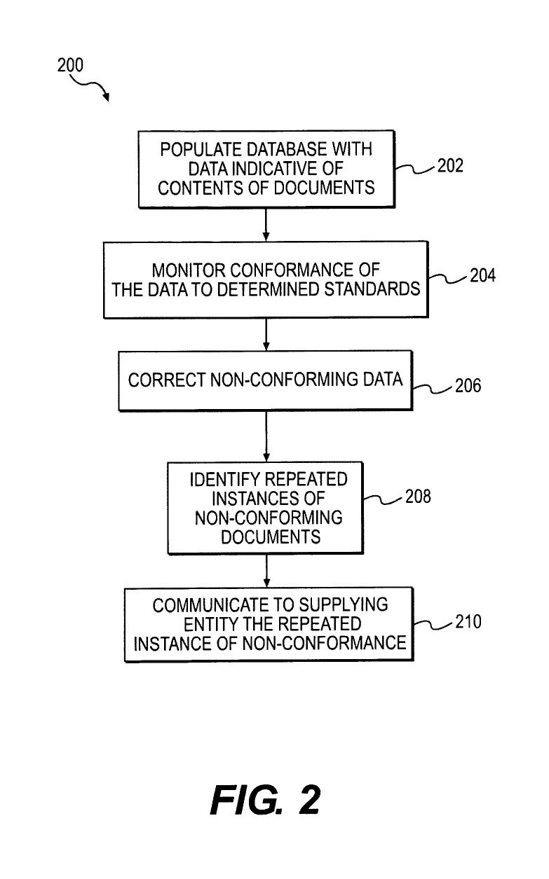

FIG. 2 illustrates a flowchart 200 depicting a method of using system 100 to monitor conformance of documents to a set of standards. FIG. 2 will be discussed in the following section to further illustrate the disclosed system and its operation.

### INDUSTRIAL APPLICABILITY

As illustrated in flowchart 200 of FIG. 2, monitoring document conformance to a set of standards may include populating database 115 with data indicative of the contents of documents (Step 202). As an example, supplying entities 140 may supply products to receiving entities 130. In addition to the supplied products, supplying entities 140 may also provide documentation related to the products, such as, for example, purchase orders, invoices, schedules, shipping notices, packing lists, and/or warehouse receipts. It is contemplated that the documents may be in hardcopy and/or electronic form. The contents of the documents may include information related to the products provided to receiving entities 130 such as, for example, product numbers, supplier identification numbers, product descriptions, quantities of products delivered, dates products were delivered, prices of products delivered, etc. Data corresponding to the information contained in the documents may be manually and/or electronically entered into database 115.

As an example, before one of supplying entities 140 supplies products to one of receiving entities 130, the supplying entity 140 may use a computer (not shown) coupled to network 120 to transmit an advanced shipping notice (ASN) document to computing system 110. The ASN document may include data indicative of the products that will be delivered by one of supplying entities 140 to one of receiving entities 130. The data indicative of the contents of the ASN document(s) may be used to populate database 115. For example, the ASN document(s) may contain, and database 115 may be populated with, product numbers, supplier identification numbers, product descriptions, quantities of products delivered, dates products were delivered, prices of products delivered, etc.

As another example, during or after one of supplying entities 140 delivers products to one of receiving entities 130, the supplying entity 140 may provide the receiving entity 130 with documents containing data indicative of the supplied products (e.g., shipping documents). The receiving entity 130 and/or the supplying entity 140 may use a computer (not shown) coupled to network 120 to transmit data indicative of the contents of the documents to computing system 110. Computing system 110 may use the transmitted data to populate database 115.

Computing system 110 may use the populated database 115 to monitor the conformance of the contents of the documents to determined standards (Step 204). The standards may be created by managers located at receiving entities 130 and/or mangers located at computing system 110. The standards may contain guidelines to ensure the documents contain complete and accurate information (e.g., accurate dates that products were shipped, accurate quantity and price of products ordered, etc.). Additional and/or different standards may be determined by managers located at computing system 110, and/or managers located at receiving entities 130.

According to one exemplary embodiment, when data indicative of a shipping document (i.e., a first data) is entered into database 115, computing system 110 may search database 115 for data indicative of a corresponding purchase order (i.e., a second data). After computing system 110 locates the second data, the first data may be compared with the second data. Any inconsistencies associated with the comparison may result in the first data being flagged. The comparison may identify inconsistencies in, for example, shipping documents that contain supplier numbers that are different than an expected supplier number (i.e., a truncated supplier number). The comparison may further identify inconsistencies in, for example, inaccurate descriptions of products delivered, inaccurate quantities of products delivered, inaccurate dates products were delivered, inaccurate prices of products delivered, and the like. Additionally, if a second data is not found, the first data may be flagged as being in non-conformance.

In yet another exemplary embodiment, an ASN document that is received after an expected time may be flagged as non-conforming. As an example, one of receiving entities 130 may send a purchase order to one of supplying entities 140. The purchase order may include information indicative of one or more items that the receiving entity 130 desires to order from the supplying entity 140. Once the supplying entity 140 is prepared to ship one or more items associated with the purchase order, the supplying entity 140 may prepare and send a corresponding ASN document to computing system 110. The ASN document may be sent electronically by, for example, email, electronic data interchange (EDI), ftp, telnet, and the like. Alternatively, the ASN document may be sent via paper-based by, for example, mail, fax, and the like. In some embodiments, if the ASN document is delivered via a paper-based means, data contained in the ASN document may be converted into an electronic format. For example, data contained in a paper-based ASN document may be converted and stored as electronic data in computing system 110 using, for example, manual data entry, optical character recognition, and the like. In either case, computing system 110 may be expecting receipt of the ASN document by a certain date. If the ASN document is received after the expected date, the ASN document may be flagged as non-conforming when it is received.

As an example, after data indicative of an ASN document is entered into database 115, CPU 111 may search database 115 for a data indicative of a receipt date of products associated with the ASN document that were delivered to a corresponding receiving entity 130. If, based on a comparison between the data indicative of a receipt date of products and the data indicative of a receipt date of the ASN document, it is determined that the products were delivered to receiving entity 130 before the data indicative of the ASN document was entered into database 115, information corresponding to the ASN document may flagged as non-conforming. It is understood that the examples listed above are non-limiting and that computing system 110 may find and identify any type of non-conforming data.

When computing system 110 identifies non-conforming data in database 115, computing system 110 may correct the data to ensure the data conforms to determined standards (Step 206). Where suitable, computing system 110 may amend data indicative of non-conforming dates, locations, supplier numbers, quantities of products delivered, and the like. The amendments may be enabled by computing system 110 comparing data in database 115 with expected and/or historical data. For example, a first data indicative of the contents of a shipping document may contain a truncated shipping number. When the first data is entered into database 115, computing system 110 may search database 115 to locate a second data indicative of a corresponding purchase order. After the second data is located, computing system 110 may compare the first data with the second data. If, based on the comparison, it is determined that the second data has a longer shipping number than the first data, computing system 110 may electronically amend the first data in database 115 to make it conform to the second data in database 115.

Additionally, computing system 110 may be configured to identify repeated instances of non-conforming data in database 115, and, as a result, computing system 110 may identify repeated instances of non-conforming documents being submitted by supplying entities 140 (Step 208). As an example, computing system 110 may be configured to identify one or more associations, traits, qualities, and/or characteristics, of the data associated with the documents with respect to the identified error(s). For example, computing system 110 may be configured to search database 115 for historical instances of non-conforming data (i.e., documents) submitted by any particular supplying entity 140. An operator of computing system 110 may be alerted to the historical instances of non-conforming data (i.e., documents) from the particular supplying entity 140.

In one embodiment, the identification of non-conforming data may be repeated on a predetermined cycle, e.g., monthly or quarterly, and previously compiled data may be deleted after a predetermined time, e.g., two or four months. As such, computing system 110 may be configured to compile and maintain data within the database 115 for a particular number of months, e.g., two or four months.

Computing system 110, and/or an operator of computing system 110, may communicate to one or more of supplying entities 140 individual and/or repeated instances non-conforming documents (Step 210). Specifically, computing system 110 may communicate with one or more of supplying entities 140 to inform them of the type and/or quantity of errors, the identified repeated instances, and/or information configured to affect a reduction or elimination in the generation of the errors (e.g., the expected format of documents being submitted). Computing system 110 may communicate the information to one or more of supplying entities 140 using electronic means, telephonic communication, postal service means, and/or any other suitable communication means.

The disclosed consolidated monitoring document conformance system may ensure that supplying entities 140 associated with receiving entities 130 are receiving consistent and constant feedback regarding the conformance of their documents. Such feedback may result in the reduction in errors in documents related to supplying entities 140, which may reduce associated logistics costs for receiving entities 130.

Those familiar with the art will appreciate that the steps in flowchart 200 may be implemented in any suitable manner. For example, it is contemplated that the steps in flowchart 200 may be performed continuously, periodically, singularly, and/or any other implementation known in the art. As an example, it is contemplated that computing system 110 may continuously monitor the conformance of data indicative of the contents of documents to a set of standards, while database 115 is continuously being populated with data indicative of the contents of documents by receiving entities 130 and/or supplying entities 140.

It is contemplated that the disclosed embodiments may not be limited to processes between a supplier and a purchaser. As an example, the disclosed embodiments may be applicable to other relationships, such as within a business entity. The business entity may include divisions, groups, etc. that interact as sub-entities for the business entity. The sub-entities may act as a user of a good supplied by a supplier sub-entity within the same business entity, such as a manufacturing business with supply division, production line division, etc.

Additionally, the disclosed method may be applicable to professional services such as, for example, medical services, insurance services, mechanical services, electrical services, construction services, etc. It is further contemplated that computing system 110 may license its service of monitoring conformance of documents to a plurality of un-related receiving entities 130. In this example, each of the receiving entities 130 may set its own standards. Computing system 110 may then monitor conformance of the respective documents to the individual standards.

It will be apparent to those skilled in the art that various modifications and variations can be made to the disclosed system and method. It is intended that the specification and examples be considered as exemplary only, with a true scope of the disclosed embodiments being indicated by the following claims and their equivalents.

What is claimed is:

1. A method for monitoring document conformance, comprising:
populating a database with data indicative of contents of a plurality of documents, the plurality of documents including a first document associated with a first supplying entity located at a first facility and a second document associated with a second supplying entity located at a second facility;
comparing data in the populated database with information indicative of a standard; and
identifying, based on the comparison, repeated instances of non-conforming documents to the standard.

2. The method of claim 1, further comprising communicating to at least one of the first supplying entity and the second supplying entity information indicative of repeated instances of non-conforming documents to the standard.

3. The method of claim 2, wherein communicating to at least one of the first supplying entity and the second supplying entity information indicative of repeated instances of non-conforming documents to the standard includes communicating information configured to affect a reduction in an occurrence of repeated instances of non-conforming documents to the standard.

4. The method of claim 1, wherein comparing data in the populated database with information indicative of the standard includes comparing data in the populated database with historical data.

5. The method of claim 1, wherein comparing data in the populated database with information indicative of the standard includes comparing data in the populated database with expected data.

6. The method of claim 1, wherein comparing data in the populated database with information indicative of the standard further includes identifying, based on the comparison, an error in data in the populated database.

7. The method of claim 6, further comprising correcting the identified error.

8. A computer-readable medium for use on a computing system, the computer-readable medium including computer-executable instructions for performing a method for monitoring document conformance, the method comprising:
populating a database with data indicative of contents of a plurality of documents, the plurality of documents including a first document associated with a first supplying entity located at a first facility and a second document associated with a second supplying entity located at a second facility;
comparing data in the populated database with information indicative of a standard; and
identifying, based on the comparison, repeated instances of non-conforming documents to the standard.

9. The computer-readable medium of claim 8, further comprising communicating to at least one of the first supplying entity and the second supplying entity information indicative of repeated instances of non-conforming documents to the standard.

10. The computer-readable medium of claim 9, wherein communicating to at least one of the first supplying entity and the second supplying entity information indicative of the repeated instances of non-conforming documents to the standard includes communicating information configured to affect a reduction in an occurrence of repeated instances of non-conforming documents to the standard.

11. The computer-readable medium of claim 8, wherein comparing data in the populated database with information indicative of the standard includes comparing data in the populated database with historical data.

12. The computer-readable medium of claim 8, wherein comparing data in the populated database with information indicative of the standard includes comparing data in the populated database with expected data.

13. The computer-readable medium of claim 8, wherein comparing data in the populated database with information indicative of the standard further includes identifying, based on the comparison, an error in data in the populated database.

14. The computer-readable medium of claim 13, further comprising correcting the identified error.

15. A system for monitoring document conformance, comprising:
a database configured to be populated with data indicative of contents of a plurality of documents, the plurality of documents including a first document associated with a first supplying entity located at a first facility and a second document associated with a second supplying entity located at a second facility; and
a central processing unit associated with the database, the central processing unit configured to:
compare data in the populated database with information indicative of a standard; and
identify, based on the comparison, repeated instances of non-conforming documents to the standard.

16. The system of claim 15, further including a network configured to communicate to at least one of the first supplying entity and the second supplying entity information indicative of repeated instances of non-conforming documents to the standard.

17. The system of claim 15, wherein information indicative of the standard includes historical data.

18. The system of claim 15, wherein information indicative of the standard includes expected data.

19. The system of claim 15, wherein the central processing unit is further configured to identify, based on the comparison, an error in data in the populated database.

20. The system of claim 19, wherein the central processing unit is further configured to correct the identified error.
